(19) United States
(12) Patent Application Publication
(10) Pub. No.: US 2013/0183451 A1
(43) Pub. Date: Jul. 18, 2013

(54) PAINTING DEVICE, PARTICULARLY FOR PAINTING ELEMENTS OF THE BODYWORK OF A MOTOR VEHICLE

(71) Applicant: Gilles Duprat, Belfort (FR)

(72) Inventor: Gilles Duprat, Belfort (FR)

(73) Assignee: FAURECIA BLOC AVANT, NANTERRE (FR)

(21) Appl. No.: 13/876,456

(22) PCT Filed: Sep. 15, 2011
(86) PCT No.: PCT/FR2011/052127

§ 371 Date: Mar. 27, 2013

(30) Foreign Application Priority Data
Sep. 28, 2010 (FR) 1057794

(51) Int. Cl. B05C 13/02

(52) U.S. Cl. CPC B05C 13/02
USPC 427/402; 118/500

(57) ABSTRACT

The invention relates to a device (10) comprising a circuit (12) for conveying at least one carriage (14) carrying at least one element to be painted, said circuit comprising a main arm (15) which passes through a loading station (16) for loading the element into the carriage (14), through a station (17) for painting the element, and through an unloading station (18) for unloading the element from the carriage (14). The circuit (12) comprises a return arm (20) extending between a first routing switch (26) on the main arm (15), which is arranged upstream from the painting station (17), and a second routing switch (28) on the main arm (15), which is arranged downstream from the painting station (17), for circulating a carriage (14) a number of times through the painting station (17) before continuing along the main arm (15).

### FIELD OF THE INVENTION

The present invention relates to an improved painting device, particularly for painting elements of the bodywork of a motor vehicle.

### BACKGROUND OF THE INVENTION

A method for painting an element of the bodywork of a motor vehicle generally includes three successive operations for depositing a coating, namely an operation for depositing a primer, an operation for depositing a base layer of paint, and an operation for depositing a varnish.

In order to perform these operations, it is possible to provide a device for painting elements including a circuit for conveying at least one carriage carrying at least one element to be painted, passing through a loading station and through a station for unloading elements in the carriage.

This painting device includes three painting stations through which the conveying circuit passes, each of these painting stations being designed to perform one of the aforementioned coating deposition operations.

Such a painting device is relatively bulky, since it includes three painting stations, and it is relatively expensive to purchase these three painting stations.

### SUMMARY OF THE INVENTION

The invention in particular aims to resolve these drawbacks, by providing a less bulky and more cost-effective painting device than in the state of the art.

To that end, the invention particularly relates to a device for painting elements, particularly elements of the bodywork of a motor vehicle, including a circuit for conveying at least one carriage carrying at least one element to be painted, said circuit comprising a main arm which passes through a loading station for loading the element into the carriage, through a station for painting the element, and through an unloading station for unloading the element from the carriage, characterized in that:
the circuit comprises a return arm extending between a first routing switch on the main arm, which is arranged upstream from the painting station, and a second routing switch on the main arm, which is arranged downstream from the painting station, for circulating a carriage a number of times through the painting station before continuing along the main arm,
the device includes means for commanding the routing switch of a carriage to the second routing switch, to route that carriage toward the return arm when the carriage has passed through the painting station a number of times that is below a predetermined number,
the painting station can perform at least two, preferably three, operations for depositing a coating layer, chosen from among depositing a layer of primer, depositing a base layer, and depositing a varnish layer, and
the routing switch control means route a carriage toward the return arm when that carriage has passed through the painting station fewer than three times, such that the painting station deposits a primer layer, deposits a base layer, and deposits a varnish layer on each element carried by the carriage.

The elements to be painted are loaded on the carriages of the conveying circuit in the same way as in the state of the art. These carriages are routed on the return arm so as to pass, in a loop, through the painting station a predetermined number of times, before being routed toward the unloading station.

This painting device therefore makes it possible to perform several operations for depositing a coating layer on the same elements to be painted, using a single painting station.

Due to the presence of a single painting station, the painting device according to the invention is less bulky than a device having a plurality of painting stations, and is that much less expensive.

It will be noted that such a painting device is particularly suitable for painting a moderate number of elements per day, for example approximately 400 pieces per day, for a limited series of motor vehicles.

The device according to the invention can also include one or more of the following features, considered alone or according to any technically possible combinations:
the circuit is formed by a dual-rail conveyor,
the painting station includes means for changing a cartridge for a coating to be deposited, capable of changing the cartridge after each passage of a carriage through that painting station,
it includes a desolvation station, through which the return arm passes downstream from the painting station, and
it includes a drying station, through which the main arm passes downstream from the second routing switch.

The invention also relates to a painting method using such a device, including:
a step for loading elements to be painted on a carriage,
a step for conveying the carriage to the painting station,
a step for routing the carriage toward the return arm, to return the carriage upstream from the painting station,
a step for conveying the carriage to the unloading station, after the conveying and routing steps have been repeated in a loop a predetermined number of times.

### BRIEF DESCRIPTION OF THE DRAWING

FIG. 1. Diagram of a painting device according to the invention.

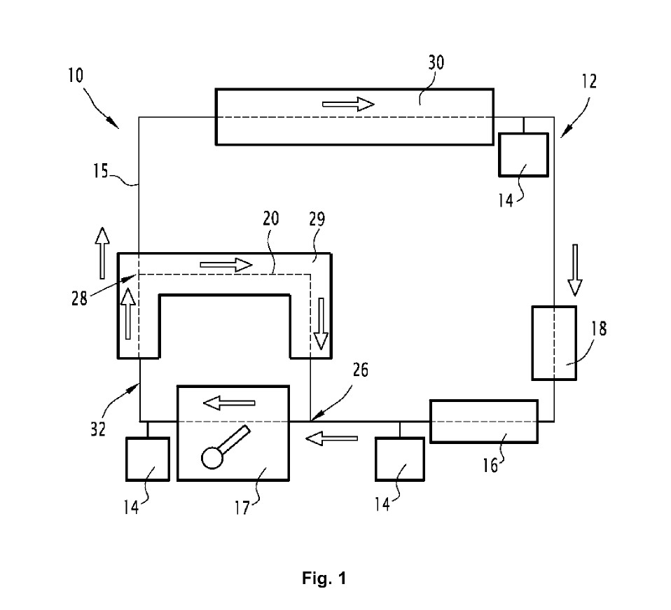

### DETAILED DESCRIPTION OF THE PREFERRED EMBODIMENT

The invention will be better understood upon reading the following description, which is provided solely as an example and done in reference to the sole appended figure, diagrammatically showing a painting device according to one example embodiment of the invention.

The figure shows a painting device 10 according to one example embodiment of the invention. This device 10 is for example designed to paint elements of the bodywork of a motor vehicle.

The painting device 10 includes a conveying circuit 12, which can convey the carriages 14 designed each to carry at least one element to be painted, for example two elements to be painted.

The conveying circuit 12 can be made in any possible manner. This circuit 12 is for example formed by a dual-rail conveyor of the traditional type.

The circuit 12 includes a main arm 15, particularly passing through a loading station 16, on which the elements to be painted are loaded in the carriages 14, through a painting station 17, and through an unloading station 18, where the painted elements are unloaded from the carriages 14.

The painting station 17 is capable of performing at least two, preferably three, operations for depositing a coating. For example, this painting station 17 can perform an operation for depositing a layer of primer, an operation for depositing a base paint layer, and an operation for depositing a layer of varnish.

To that end, the painting station 17 preferably includes means for changing a coating cartridge, capable of replacing a cartridge used after each passage of a carriage 14 through the painting station 17.

The circuit 12 also includes a return arm 20, extending between a first routing switch 26 with the main arm 15, arranged upstream from the painting station 17, and a second routing switch 28 with the main arm 15, arranged downstream from the painting station 17.

Thus, each carriage 14 can be routed toward the return arm 20 so as to pass a predetermined number of times through the painting station 17, so as to receive successive coating layers. It is thus possible to produce the successive operations for depositing a layer of primer, a base paint layer, and a layer of varnish using corresponding successive coating cartridges.

Advantageously, the return arm 20 also passes through a desolvation station 29, designed to eliminate the solvent contained by the coating layer deposited on the element during the prior passage of the carriage 14 through the painting station 17, so as to facilitate the later deposition of another coating layer.

For each carriage 14 to be able to pass a predetermined number of times through the painting station 17, the device 10 includes means for routing the carriage 14 at the second routing switch 28 toward the return arm 20 when the carriage 14 has passed through the painting station 17 a number of times lower than a predetermined number. Preferably, this predetermined number is three times, so that the painting station 17 can perform the successive operations of depositing a layer of primer, a layer of base paint, and a layer of varnish on the element carried by the carriage.

For example, the device 10 is programmable, so as to program a predetermined path for each carriage 14, that predetermined path providing that the carriage 14 passes the predetermined number of times through the painting station 17, before being routed toward the unloading station 18 at the second routing switch 28.

Advantageously, the device 10 includes a drying station 30, through which the main arm 15 passes downstream from the second routing switch 28 and upstream from the unloading station 18, so that the coating deposited on the elements carried by the carriage 14 is dry before unloading.

Preferably, the conveying circuit 12 includes a rapid segment 32, in which the conveying of the carriages 14 is faster than in the rest of the conveying circuit 12. This rapid segment 32 extends over the main arm 15 between the first 26 and second 28 branches, and on the return arm 20. In other words, this rapid segment forms the loop allowing the carriages 14 to pass the predetermined number of times through the painting station 17.

The conveying speed on the rapid segment 32 is for example chosen to allow a flow rate of carriages 14 three times greater than on the rest of the circuit 12. In fact, in the case where each carriage 14 passes three times through the painting station 17, a first carriage arriving on the rapid segment 32 must go three times around that rapid segment before a second carriage in turn arrives on that rapid segment.

It will be noted that the painting device according to the invention makes it possible to carry out a painting method as described below.

The method first includes a step for loading elements to be painted on a carriage 14, followed by a step for conveying the loaded carriage 14 to the painting station 17.

The method then includes a step for conveying the carriage 14 by passing through the return arm 20 so as to pass, in a loop, through the painting station 17 a predetermined number of times, for example three times, such that the painting station 17 performs the predetermined number of operations for depositing a coating.

In other words, the method includes the following steps:
first passage of the carriage 14 through the painting station 17,
deposition, by the painting station 17, of a layer of primer on the elements carried by the carriage 14, and changing the coating cartridge of the painting station 17, for a base paint cartridge,
routing the carriage 14 toward the return loop 20, since the carriage 14 has passed through the painting station 17 at least three times,
first passage of the carriage 14 through the desolvation station 29,
second passage of the carriage 14 through the painting station 17,
deposition, by the painting station 17, of a base paint layer on the elements carried by the carriage 14, and changing the coating cartridge of the painting station 17, for a varnish cartridge,
routing the carriage 14 toward the return loop 20, since the carriage 14 has passed fewer than three times through the painting station 17,
second passage of the carriage 14 through the desolvation station 29,
third passage of the carriage 14 through the painting station 17,
deposition, by the painting station 17, of a layer of varnish on the elements carried by the carriage 14, and changing the coating cartridge of the painting station 17, for a primer cartridge.

After the carriage 14 has passed the predetermined number of times through the painting station 17, the routing means no longer route the carriage 14 toward the return arm 20, but route it on the main arm 15 toward the unloading station 18.

The method then includes a step for conveying the carriage 14 through the drying station 30, followed by a step for conveying the carriage 14 toward the unloading station 18.

The method lastly includes a step for unloading the painted elements from the carriage 14, following which the carriage 14 is again conveyed toward the loading station 16.

It will be noted that the invention is not limited to the embodiment previously described, but may assume various alternatives without going beyond the scope of the claims.

For example, the device may include a main circuit, including the loading and unloading stations, and a second circuit, including the painting station. In that case, the routing switches would be formed by means for transferring carriages between the main and secondary circuits.

1. A device for painting elements, particularly elements of the bodywork of a motor vehicle, comprising a circuit for conveying at least one carriage carrying at least one element to be painted, said circuit comprising a main arm which passes through a loading station for loading the element into the carriage, through a station for painting the element, and through an unloading station for unloading the element from the carriage, wherein:
the circuit comprises a return arm extending between a first routing switch on the main arm, which is arranged upstream from the painting station, and a second routing switch on the main arm, which is arranged downstream from the painting station, for circulating a carriage a number of times through the painting station before continuing along the main arm,
the device comprising a routing switch controller for commanding the routing switch of a carriage to the second routing switch, to route the carriage toward the return arm when the carriage has passed through the painting station a number of times that is below a predetermined number,
the painting station can perform at least two, preferably three, operations for depositing a coating layer, chosen from among depositing a layer of primer, depositing a base layer, and depositing a varnish layer, and
the routing switch controller routes a carriage toward the return arm when the that carriage has passed through the painting station fewer than three times, such that the painting station deposits a primer layer, deposits a base layer, and deposits a varnish layer on each element carried by the carriage.

2. The painting device according to claim 1, wherein the circuit is formed by a dual-rail conveyor.

3. The painting device according to claim 1, wherein the painting station comprising a device configured to change a cartridge for a coating to be deposited, capable of changing the cartridge after each passage of a carriage through the painting station.

4. The painting device according to claim 1, comprising a desolvation station, through which the return arm passes downstream from the painting station.

5. The painting device according to claim 1, comprising a drying station, through which the main arm passes downstream from the second routing switch.

6. A painting method using a device according to claim comprising:
a step for loading elements to be painted on a carriage,
a step for conveying the carriage to the painting station,
a step for routing the carriage toward the return arm, to return the carriage upstream from the painting station, and
a step for conveying the carriage to the unloading station, after the conveying and routing steps have been repeated in a loop a predetermined number of times.
